(19) United States
(12) Patent Application Publication
(10) Pub. No.: US 2005/0101266 A1
(43) Pub. Date: May 12, 2005

(54) Method for dynamic channel allocation

(76) Inventors: Dietmar Jurschik, Kempten (DE); Gunther Schauer, Unterschleissheim (DE); Armin Tannhauser, Muenchen (DE)

Correspondence Address: BELL, BOYD & LLOYD, LLC, P. O. BOX 1135, CHICAGO, IL, 60690-1135, US

(21) Appl. No.: 10/477,290

(22) PCT Filed: Apr. 22, 2002
(86) PCT No.: PCT/DE02/01473

(30) Foreign Application Priority Data
May 9, 2001 (DE) 101 22 419.2

(51) Int. Cl. H04B 1/034

(52) U.S. Cl. 455/100

(57) ABSTRACT

A method designated as Dynamic Rate Repartitioning (DRR) is provided, which allows temporary allocation of temporarily not-in-use time-multiplex based transmission channels of telephone or ISDN-links like channeled voice over DSL/CVoDSL to a simultaneously active ATM-link, in an SDSL/SHDSL- or ADSL frame of a corresponding DSL-link. The method increases the data rate and makes a more intensive use of the transmission capacity of the DSL-link. Switching is carried out with frame synchronization and without data loss, wherein bit positions can be maintained.

### BACKGROUND OF THE INVENTION

The combined use of the telephone or ISDN network (ISDN—Integrated Services Digital Network) and the Internet has made the transport of different communication services on the conventional subscriber line DSL (Digital Subscriber Line) an important technology.

A number of systems are available for connecting the various customer premises equipment for conventional telephony/ISDN or broadband applications. Both time division multiplex and ATM techniques (ATM—Asynchronous Transfer Mode) are used as the transmission format, ADSL (Asymmetric Digital Subscriber Line) and SDSL (Symmetric Digital Subscriber Line) being well-known transmission methods. The present invention relates to both of these methods, ADSL and SDSL. For symmetric digital subscriber line, the abbreviation SHDSL (Symmetric High Bit Rate Digital Subscriber Line) is also commonly used.

With both methods, telephone connections and/or ISDN connections can be operated simultaneously with data links on the subscriber line and can be set up and terminated individually and independently of one another. In the interest of intensive used of the line, it is particularly advantageous, for example, to leave the transmission channel of a just terminated telephone or ISDN connection unused during the period up to the next connection request, using instead a simultaneously active ATM data channel to temporarily increase the throughput volume. The associated allocation or taking-back of the additional channel must not cause any loss of data in the ATM channel. This principle of intensively utilizing transmission channels is known as dynamic channel allocation or dynamic rate repartitioning (DRR).

An object of the present invention is to specify a method for this purpose. This method has the advantage of increasing the data transmission capacity of the ATM channel without loss of data.

The advantage of this, in turn, is that the existing telephone and ISDN connections are unaffected.

The inventive method offers the further advantage that, when the channels additionally carrying ATM are taken back, this taking-back causes no impairment of a new connection setup for ISDN and telephony.

Additional features and advantages of the present invention are described in, and will be apparent from, the following Detailed Description of the Invention and the Figures.

### BRIEF DESCRIPTION OF THE FIGURES

FIG. 1 shows an SDSL frame structure.

FIG. 2 shows three examples of timeslot assignment in an SDSL frame.

FIG. 3 shows two examples of a timeslot switchover.

FIG. 4 shows an example of a channel allocation and switchover procedure.

FIG. 5 shows an example of a command structure for channel allocation.

FIG. 6 shows an example of a switchover procedure.

FIG. 7 shows an example of a frame control unit.

FIG. 8 shows an example of a disturbed procedural sequence.

FIG. 9 shows another example of a disturbed procedural sequence.

FIG. 10 shows yet another example of a disturbed procedural sequence.

FIG. 11 shows an ADSL frame structure.

### DETAILED DESCRIPTION OF THE INVENTION

For the following considerations, data transport via an SDSL frame and then viaan ADSL frame will be discussed. Payload bits, signaling bits and service bits are transmitted at defined bit positions in this frame.

It is well known that for various SDSL applications, the service bits and the signaling bits can be transmitted within the frame, in accordance with ETSI standard TS 101 524 or ITU standard G.991.2, in the so-called overhead area where they are also transmitted in the eoc channel (embedded operations channel), or in one or more 8-kbit/s Z-channels provided as an expansion or in one or more 64-kbit/s B-channels. The protocol sequences for controlling telephone and ISDN connections likewise have been standardized in accordance with ETSI EN 300 324-1. Also standardized is the assignment of 64-kbit/s timeslots in the SDSL frame to the payload information of one or more telephone and ISDN connections.

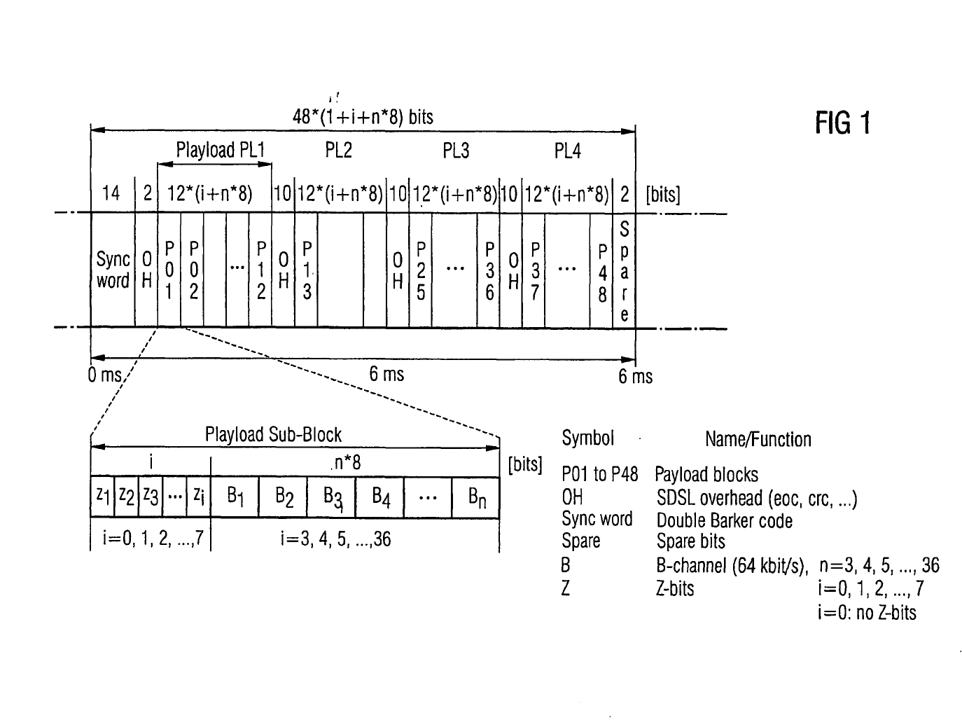

FIG. 1 shows the structure of a standard SDSL frame as specified by the European Telecommunications Standards Institute ETSI and the International Telecommunication Union ITU.

The frame is subdivided into four payload blocks PL1, PL2, PL3 and PL4. Each payload block PL1, PL2, PL3, PL4 is in turn subdivided into 12 payload sub-blocks P01 to P12, P13 to P24, P25 to P36 and P37 to P48.

Each sub-block can be subdivided into up to seven 8-kbit/s Z-channels and up to thirty-six 64-kbit/s B-channels, each Z-timeslot including 1 bit position and each B-timeslot 8 bit positions. Signaling bits as well as operational bits for telephone and ISDN connections can be transmitted in a number of Z-timeslots and/or adjacent B-timeslots specified as required when the SDSL link is configured. The information bits of the B1- and B2-channels of an ISDN connection are transmitted in 2 consecutive B-timeslots of an SDSL frame. The digitized signals of the telephone connections are likewise transmitted in B-timeslots, one B-timeslot being assigned to each telephone connection and the relevant number of telephone B-timeslots and ISDN B-timeslot pairs required likewise being specified when the SDSL link is configured. The data of the ATM connection is concentrated in another configured number of 64-kbit/s timeslots. The total number of B-timeslots is determined by the transmission rate of the current SDSL system and is between 3 and 36 as indicated in FIG. 1.

The overhead (OH) accommodates overhead data (data concerning the payload) containing individual bit positions for the operational information, and, with approximately 3.3 kbit/s transport capacity, the eoc channel.

In addition, the frame has at its start a 14 bit long sync word (synchronization word) for frame alignment and two bits at the end of the frame for adapting the frame length.

As has been explained in the frame description in connection with FIG. 1, specified numbers of timeslots for the signaling of connections including operational information, for the telephone connections, for the ISDN connections and for a broadband connection, in particular ATM connection, are reserved when the SDSL link is configured; e.g., in a so-called handshaking procedure.

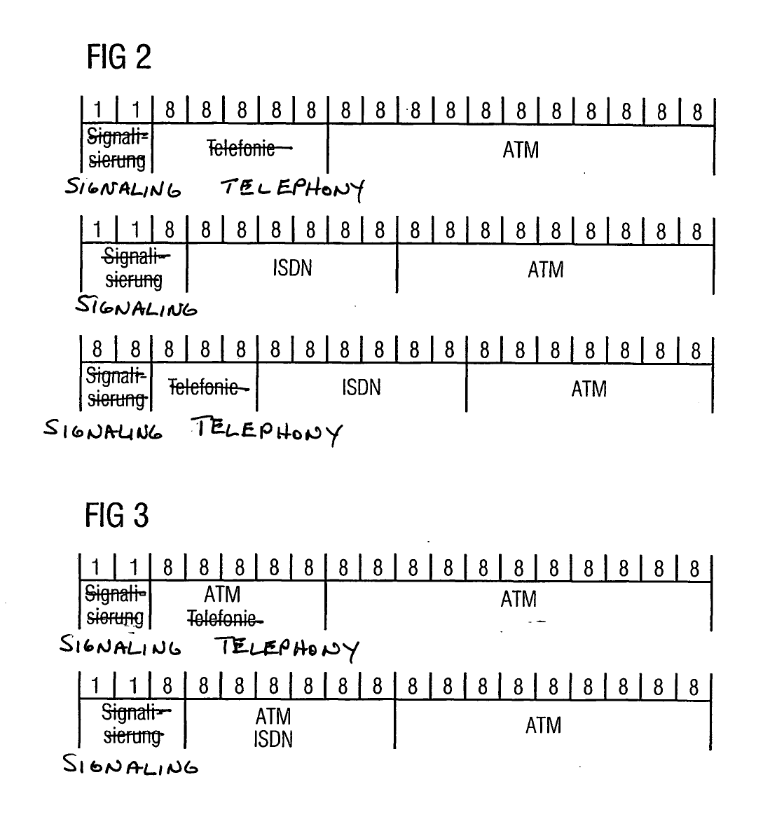

FIG. 2 shows further examples of such timeslot assignments. The first example shows 2 timeslots of 1 bit each (Z-timeslots) for signaling, 5 additional timeslots of 8 bits each (B-timeslots) for time-division-multiplex-based telephony applications and the remaining timeslots for an ATM-based connection. The next example shows channel partitioning into the areas of signaling, then ISDN instead of telephony, and again ATM, whereas the last example illustrates the simultaneous use of telephony, ISDN and ATM services.

During operation, not all the reserved telephone and ISDN channels are occupied all the time. According to the present invention, a method for using the temporarily unassigned telephone and ISDN timeslots will now be specified. This has the advantage of increasing the transport capacity of the ATM connection.

It is assumed that, as described above, during configuration of an SDSL link the assignment of the timeslots to the communication services is preset, examples of which are shown in FIG. 2. This presetting remains in force as long as the SDSL link exists. According to the present invention, timeslots can be temporarily assigned to an ATM-based service. If, for example, a telephone subscriber on the SDSL line hangs up after a call (goes on-hook), the temporarily no longer required 64-kbit/s timeslot for the digitized speech is released with the disconnect command. According to the present invention, this timeslot is immediately assigned functionally to the ATM timeslot area. This is illustrated in the first example in FIG. 3 by the shading of the preset ATM area and of the timeslot switched from the telephony area having the italicized designation ATM. This switching for ATM communication takes place seamlessly and without loss of data. In the example shown, the enlarged ATM area has no closed timeslot block, as there is another active telephony timeslot, for example, between the preset area and the timeslot connected thereto.

According to the present invention, the same applies analogously to the ISDN timeslots, as the second example in FIG. 3 shows. According to the present invention, the B-channel timeslot pair of an ISDN connection is switched to the ATM area without additional jumpering after it has been released by the disconnect command.

For ATM operation, this means that, in the two examples described, the ATM cells must be injected into separate timeslot areas of the frame. It is an advantageous aspect of the present invention that the telephony timeslots and ISDN timeslot pairs temporarily switched to the ATM channel are not jumpered, thereby eliminating interference to existing telephone and ISDN connections.

According to the present invention, the timeslots or timeslot pairs temporarily switched away from the telephone and ISDN area remain assigned to the ATM area until they are again required in their preset area as the result of a connection request for telephony or ISDN.

To initiate the procedures for channel allocation to the ATM link or back to the telephony or ISDN area, commands of standard EN 300 324-1 can be used. These are “Disconnect” for assigning a telephony timeslot to the ATM link, “Deactivate” for assigning an ISDN timeslot pair to the ATM link, “Establish” for returning the telephony timeslot to the telephony area and “Activate” for returning an ISDN timeslot pair to the ISDN area. This definition has the advantage that the assignment and switchover procedures can be seamlessly linked to existing signaling procedures for setting up and terminating connections.

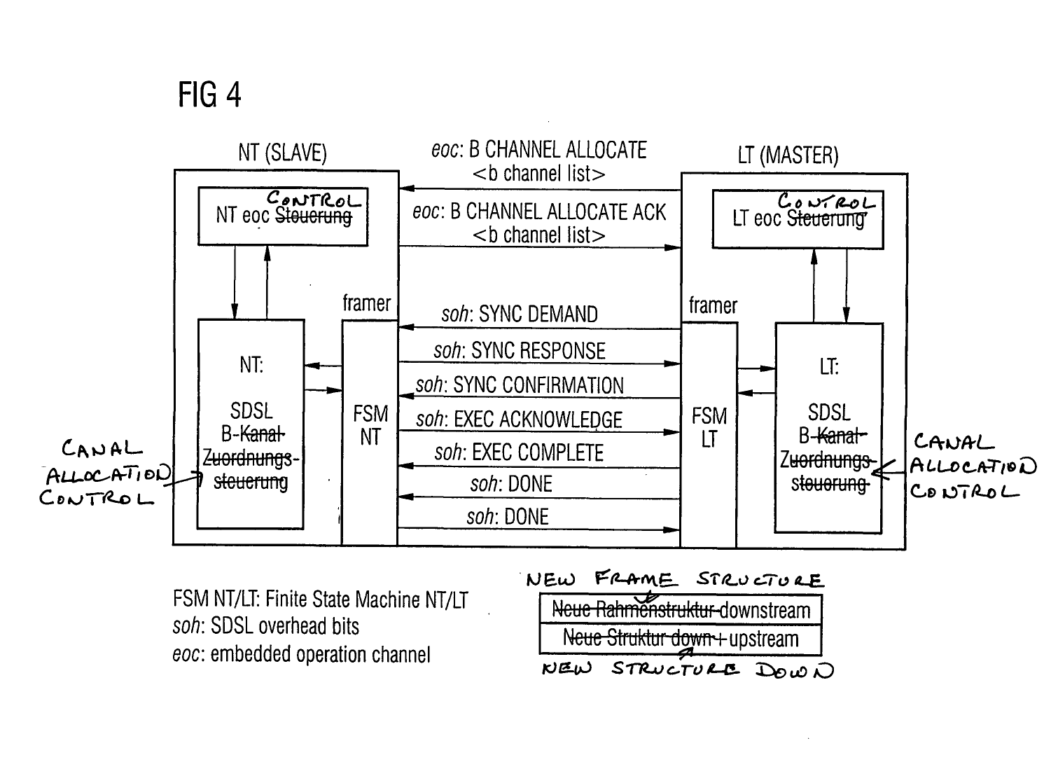

The assignment and switchover procedure initiated by the commands in accordance with EN 300 324-1 is illustrated in an example in FIG. 4. It is controlled on the network side by the SDSL-LT (LT—Line Termination) as the master with, the subscriber-side NT (NT—Network Termination) acting as the slave. The master (LT) first notifies the slave (NT) of the timeslot(s) to be changed over using the command “B Channel Allocate” in a list of the telephone and ISDN timeslots. NT confirms the new allocation with the answer “B Channel Allocate Ack”.

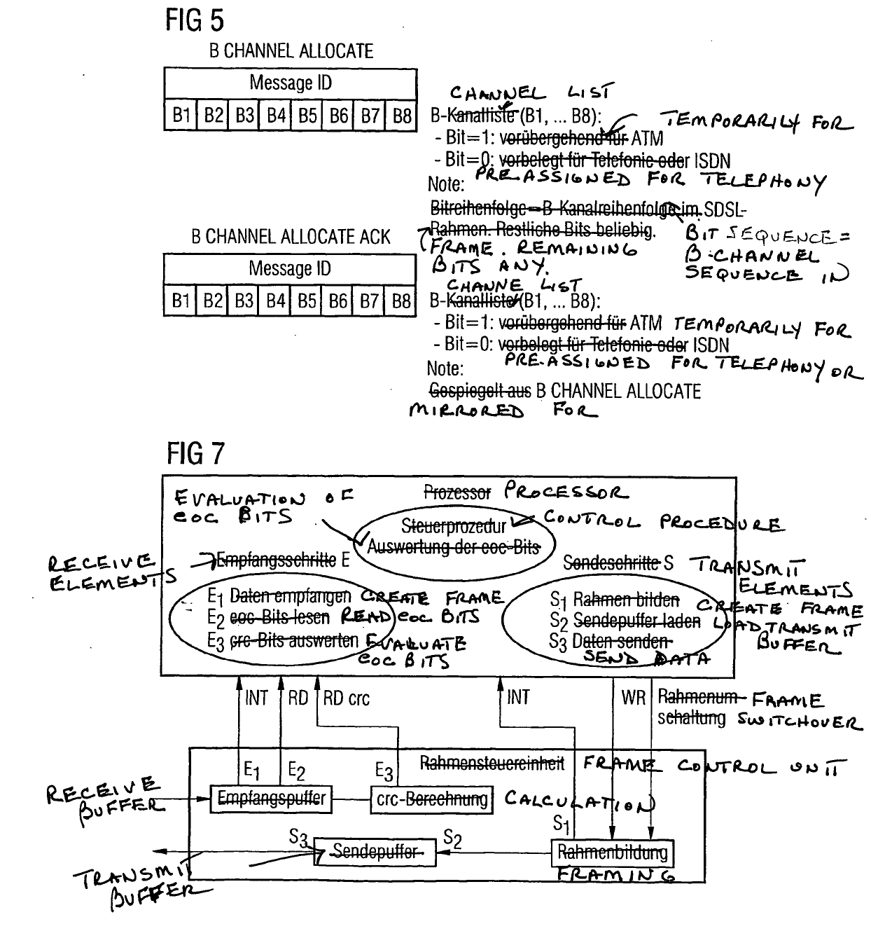

FIG. 5 shows an example of the implementation of the assignment commands B Channel Allocate and B Channel Allocate Ack. Both messages are preferably transmitted in the eoc channel. They are marked by a message identifier (Message-ID) containing the abovementioned message names. The message content is accommodated in one byte, each of the 8 bits identifying a B-channel timeslot in the telephony or ISDN area. Subscriber lines with up to 8 telephone lines or 4 ISDN accesses or suitable combinations of the two can, therefore, be served using the 1-byte content. In further embodiments, lines with correspondingly more telephone and/or ISDN connections also can be served using 2 or more bytes as shown. The sequence of the bits in the byte or bytes continuously corresponds to the sequence of the B-channel timeslots in the SDSL frame. B-channels temporarily allocated to the ATM area and to be newly allocated thereto are designated by 1, whereas channels in the basic telephony or ISDN setting or channels to be switched back are designated by 0. The list is mirrored back by NT in the acknowledgment B Channel Allocate Ack.

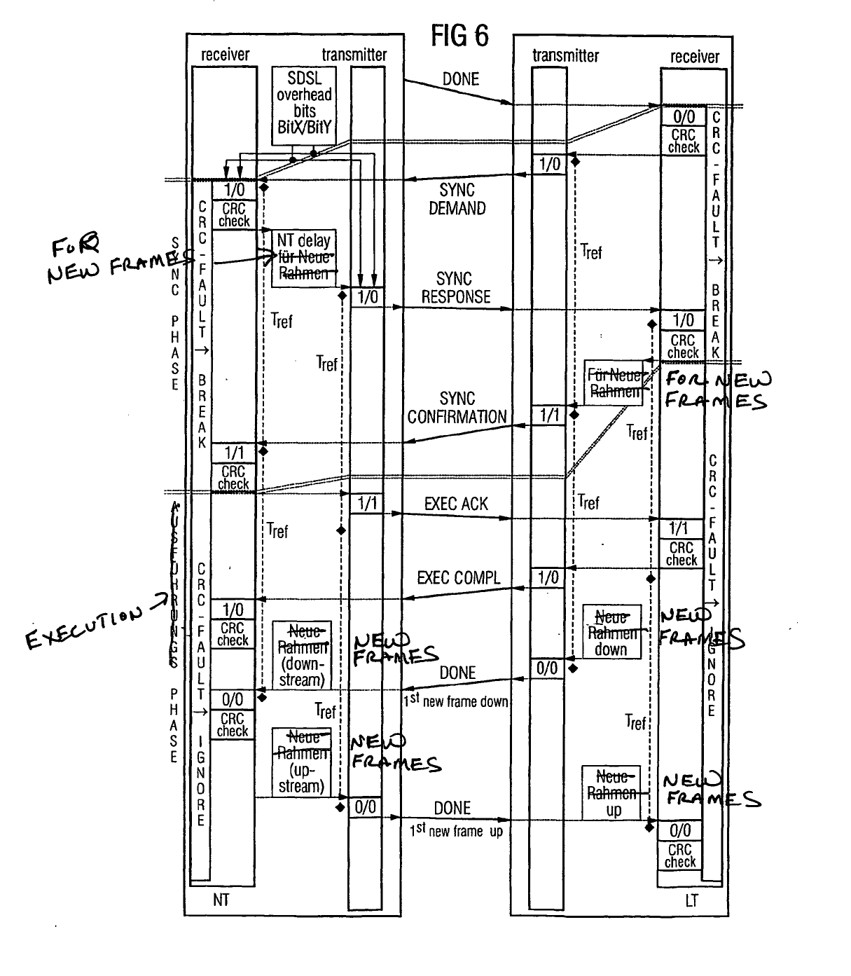

The switchover procedure following the allocation procedure is bit-controlled, so that the conventional duration of telephone and ISDN connection setup is not noticeably extended by the switchover and is frame-synchronized, ensuring that no loss of data occurs in the existing ATM link. The sequence of the switchover procedure is illustrated in an example in FIGS. 6, 8, 9, and 10. Communication between LT and NT takes place via 2 cyclic redundancy checks (error detection using cyclic code), CRC-protected bits in the OH area of the SDSL frame, preferably bit nos. 24 and 36, the bit significances in the upstream and downstream frame being independent of one another. In the ETSI and ITU SDSL standards the two bit positions are as yet unused.

From the idle state of LT and NT, which is defined by Bit24/Bit36=0/0, the LT procedure is initiated by the message Bit24/Bit36=1/0, “Sync Demand”, sent downstream to NT. With the transmission or arrival of the first frame with Sync Demand, the reference or synchronization point for subsequently defining the transmit and receive time of the first downstream frame with a new channel structure in LT or NT, is already fixed in LT and NT respectively. With the CRC-protected receipt of Sync Demand, NT in turn initiates the switchover procedure using the currently valid channel allocation list transmitted with the B Channel Allocate command. After an NT-specific delay according to the present invention, as described below, NT sends the message Bit24/Bit36=1/0, “Sync Response”, upstream to LT. With the transmission or arrival of the first frame with Sync Response, the starting point for subsequently defining the transmit and receive time of the first upstream frame with a new channel structure in NT or LT, is now also fixed in NT and LT respectively. LT answers after the CRC-protected receipt of Sync Response and after an LT-specific delay according to the present invention, as described below, with the message Bit24/Bit36=1/1, “Sync Confirmation”. LT counts the SDSL frames beginning with the first transmitted frame with Sync Demand up to and including the last frame prior to the transmission of Sync Confirmation and therefore knows, for LT, the reference time T_{Ref} governing the transmission and receipt of the first frame with the new channel allocation. NT likewise determines the reference time T_{Ref} by counting the frames beginning with the first incoming frame with Sync Demand up to and including the last frame prior to the arrival of Sync Confirmation.

As illustrated in FIG. 6, the reference time, measured in frame lengths, is defined as the time between transmission of the frame with the LT message Sync Demand and transmission of the frame with the LT message Sync Confirmation. T_{Ref} therefore contains, first of all, the loop delay between LT and NT, the time for CRC-evaluation and transmit framing without new channel allocation in the NT as well as the time for CRC-evaluation and transmit framing without new channel assignment in the LT (cf., FIG. 7, showing the example of a frame control unit). These elements constitute the system reaction time between receiving and responding to a CRC-protected frame in the initial protocol cycles. According to the present invention, T_{Ref} contains another 2 time portions. The primary purpose of T_{Ref} is to define the switchover times for the frames with the new channel structure at the end of the procedure. At the end of the procedure, framing is extended by additional switching steps for adapting to the changed channel structure in LT and NT. This is taken into account in T_{Ref} by the insertion of additional time intervals. These additional time intervals can be of different lengths depending on the relevant, also manufacturer-specific, HW/SW implementation in the LT and in the NT. According to the present invention, both additional intervals can be configured separately in order to ensure interoperability.

When the procedure is operating properly, according to the present invention the first new frames are transmitted or received by the LT and NT in the time interval 2 T_{Ref} according to the previously specified reference points. The time instants for frame switchover in the upstream or downstream direction are defined in LT and NT by the transmission and receipt of the same frame in each case, and therefore ensure a frame-synchronized switchover.

A further advantage of the inventive extending of T_{Ref} by the time portions for switching over to the changed channel allocation is that the message exchange up to the execution confirmation described below is terminated with a time lead compared to the predetermined switchover time 2 T_{Ref}. As explained below, this lead forms a buffer when the procedure sequence is delayed by transmission disturbances.

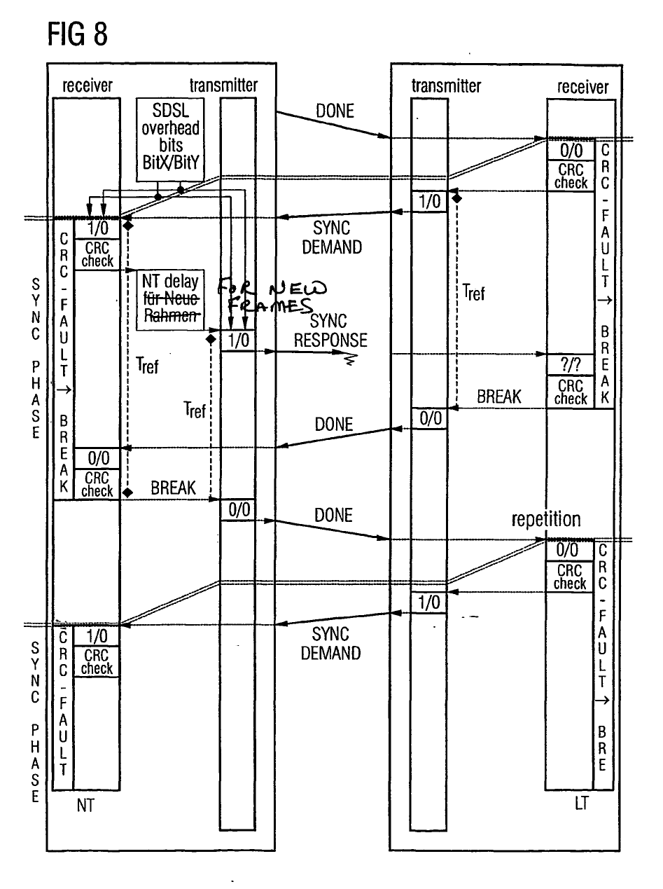

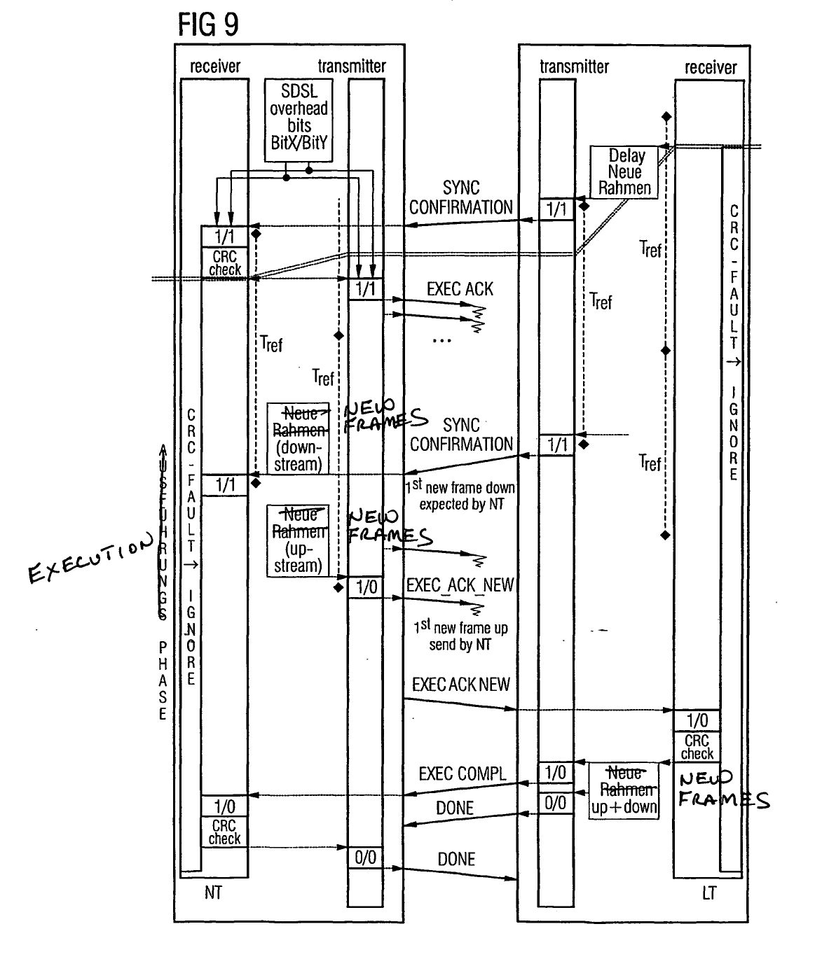

Up to this point (i.e., up to the CRC-protected arrival of Sync Response in LT, and of Sync Confirmation in NT), the LT and NT abort the procedure in the event of each CRC-detected fault or each CRC-protected receipt of the reset message Bit24/Bit36=0/0, “Done”, and return to the idle condition with immediate restart by LT. This is illustrated in an example in FIG. 8.

The phase thus far described constitutes the synchronizing phase of the switchover procedure, at the end of which the switchover times to the frames with the new channel allocation have been established at both ends for both LT and NT.

The synchronizing phase is followed by the execution phase with the actual frame switchover (cf., FIG. 6). After the arrival of Sync Response and Sync Confirmation, respectively, LT and NT no longer abort the switchover procedure in the event of a CRC alarm. Following the CRC-protected receipt of Sync Confirmation, NT signals with Bit24/Bit36=1/1, “Exec Ack”, the final determination to switch over to the new frames at the known send and receive times in the NT. LT confirms the CRC-protected receipt of Exec Ack with Bit24/Bit36=1/0, “Exec Complete”. LT thereby acknowledges the determination of NT to switch over to the new frames at the predetermined send and receive times and specifies that NT, with this switchover, cancels the Exec Ack message. With the first new frames to the NT and to the LT, the signaling bits are reset to Bit24/Bit36=0/0, “Done”, in order to indicate orderly switchover as well as the return of LT and NT to the idle state of the procedure, with which LT and NT are prepared for subsequent switchover requests.

In the procedural sequence illustrated in FIG. 6, it is assumed that the process is free from transmission disturbances with CRC alarm. Normally, on average, less than every ten millionth bit is corrupted by faults during transmission, so that lengthy transmission disturbances very rarely occur. In the event of a CRC alarm resulting from frame error monitoring, the signaling bits of the frame affected are invalid for the switchover procedure. As described above, the protocol is aborted at every CRC alarm during the protocol synchronizing phase (cf., FIG. 8). The LT and NT are therefore reset and re-start, LT-initiated, with Sync Demand. In the execution phase, as mentioned above, resetting does not occur in the event of an CRC alarm. Should a transmission fault with CRC alarm in the LT now begin during the execution phase with transmission of the first frame with Exec Ack to the LT, this delays the recognition of Exec Ack in the LT and, therefore, under certain circumstances as described in greater detail below, the switchover of transmitter and receiver in the LT to the new frames. This is illustrated in an example in FIG. 9. However, a single correctly received frame with Exec Ack in the LT is all that is required to continue the procedure. If in this case Exec Ack is detected well before the predetermined switchover time, the disturbance has no effect on the procedure.

If the transmission line disturbance and therefore the CRC alarm persists for so long that the predetermined switchover time in the LT is overshot, the new frame is formed and sent out immediately after the end of the CRC alarm and recognition of Exec Ack. The predetermined switchover times are retained in the NT. In the time between its own predetermined switchover time and the switchover time delayed in the LT by the disturbed line, the NT receives frames with the old instead of the expected new channel structure. This downstream frame disturbance caused by the line disturbance does not affect the existing telephone and ISDN connections, as their channel allocation (downstream as well as upstream) is not changed. It is also terminated in a “self-healing” manner with the arrival of the new structure in the NT at the end of the transmission disturbance.

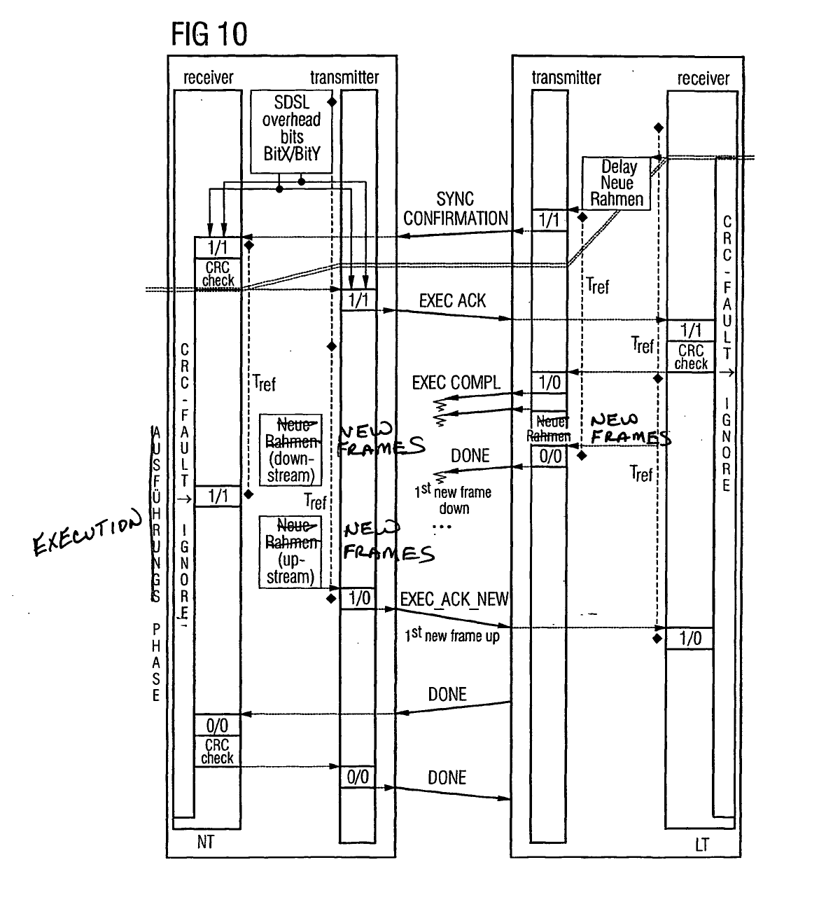

The same applies upstream even if the line disturbance and therefore the CRC alarm in the LT persists beyond the predetermined time for receiving the first new upstream frame. After a delay, the LT switches over to receiving new frames as soon as, in an error-free pause in the transmission disturbance, at least one valid frame is received with Exec Ack or, because of the already performed frame switchover in the NT, with Exec Ack New. Consequently, the upstream frame disturbance caused by the line disturbance is also terminated in the LT in a self-healing manner. The message Exec Ack New, Bit24/Bit36=0/0, is transmitted by NT with the new frames if, because of the transmission disturbance, NT has not yet received an Exec Complete message prior to switchover to transmission of the new frames. This is illustrated in FIG. 10. LT acknowledges detection of Exec Ack New in the same way as detection of Exec Ack with the transmission of Exec Complete and terminates the procedure with the transmission of Done after frame switchover and return to the idle state. After CRC-protected receipt of Exec Complete or Done, NT in turn sends the message Done to LT and reverts to the idle state.

If transmission disturbances produce a CRC alarm only in the NT, frame switchover takes place at both ends as if there were no disturbance, as NT (by—definition) and LT (because no CRC alarm is present) do not change the predetermined switchover times. In this case it is only the return of NT to the idle state that is delayed by the line disturbance due to the late detection of Exec Complete or Done (cf., FIG. 9).

The described cases of temporary but self-healing frame disturbance caused by lengthy continuous transmission disturbances occur very rarely during normal operation due to the low permissible bit error rate. In a further embodiment according to the present invention, the probability of a frame disturbance can be further minimized to any required extent. As described above, a transmission disturbance has no effect on frame switchover if Exec Ack is detected in the LT with a delay but still before the switchover time defined by T_{Ref}. Naturally, the longer this buffer, the more effective it is, as the probability of continuous transmission disturbances reduces markedly with their length. In another embodiment according to the present invention, T_{Ref} is therefore extended by a configurable buffer time, thereby reducing the probability of frame disturbances to any required extent. In a further embodiment according to the present invention, the probability of disturbances is reduced by lengthening the buffer time by shifting the switchover time to new frames by configurable integral multiples of T_{Ref}.

In the described example of FIG. 6, the duration of the undisturbed procedure is approximately 2.5 T_{Ref}. With 4 frame lengths per T_{Ref} in the case of complete implementation in HW and an SDSL frame length of 6 ms, this gives a time of 60 ms for the bit-controlled procedure without loop delay; i.e., on short subscriber lines. This is short in relation to normal telephone or ISDN connection setup in the multi-second range.

In a further embodiment of the present invention, a dynamic channel allocation solution is specified for ADSL transport. With ADSL, the time-division-multiplex-based services are preferably termed “Channelized Voice over DSL” (CVoDSL) because of their channel orientation. Standardization of CVoDSL is currently underway on the basis of the ITU G.Voice standard. This is being done primarily because CVoDSL enables the delay compensation costs associated with ATM-based voice communication, VoDSL (Voice over DSL), to be avoided.

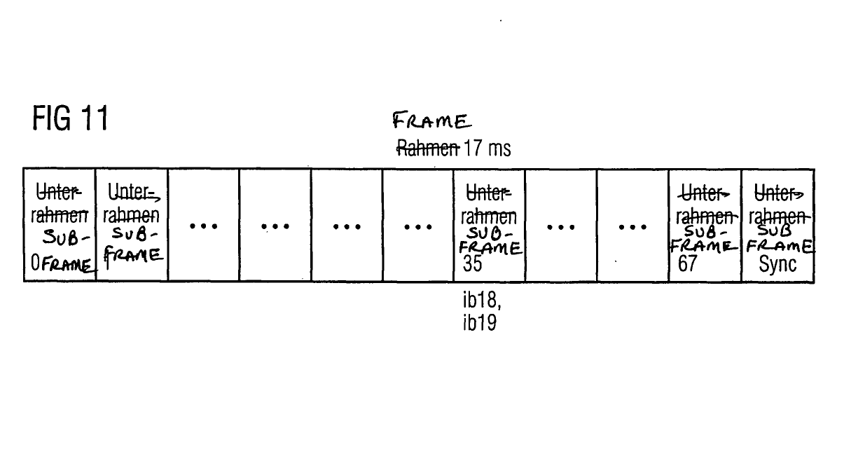

The ADSL frame can normally be broken down into interleaved and non-interleaved sections. The non-interleaved section is, in principal, as with SDSL, subdivided into areas for CVoDSL and ATM, the individual CVoDSL channels for telephony and ISDN being identified by their position in the ADSL frame and preset when configuring an ADSL link. According to the present invention, a CVoDSL channel which, as in the case of SDSL, is identified by a message to establish or terminate a connection, is switched to the ATM area or switched back to the CVoDSL area. According to the present invention, commands of standard EN 300 324-1 are used, as in the case of SDSL, to initiate the procedures for switching channels to the ATM link and switching channels back to the telephony or ISDN area. As described for SDSL, these are “Disconnect”, “Deactivate”, “Establish” and “Activate”. This specification has the advantage that the same link signaling can be used for CVoDSL and VoDSL transport, as the signaling has already been standardized for VoDSL in accordance with EN 300 324-1. To transport the CVoDSL signaling for ADSL, an HDLC channel in the overhead area of the ADSL frame has already been proposed in ITU for G.Voice. Cf. ITU document IC-045, 2001. This channel is used for transmitting the channel allocation commands according to the present invention. As in the case of SDSL, these commands are “B Channel Allocate” and “B Channel Allocate Ack”, the message content including, structured byte-wise for telephony or ISDN, the position(s) of the CVoDSL-B channel(s) to be switched over which are mirrored back in the confirmation message. The confirmation message, as in the case of SDSL, is followed by the bit-controlled switchover procedure, including the possibility of extending it by an additional buffer (cf., FIGS. 6, 8, 9 and 10 and the associated description). According to the present invention, communication between LT and NT takes place, as in the case of SDSL, via 2 CRC-protected bits, here preferably at bit positions ib18 and ib19 in sub-frame 35 of the ADSL (cf., FIG. 11). In the ADSL standard both bits are unused.

The procedure described in FIG. 6 is based, for ADSL, on a frame length of 17 ms compared to 6 ms in the case of SDSL. On otherwise identical assumptions, it is some three times as long as for SDSL; i.e., approximately 180 ms. Even this value is short compared to connection setup times of several seconds.

Indeed, although the present invention has been described with reference to specific embodiments, those of skill in the art will recognize that changes may be made thereto without departing from the spirit and scope of the present invention as set forth in the hereafter appended claims.

1-22. (canceled)

23. A method for operating time-division-multiplex-based telephone and ISDN data links with an ATM-based data link via a synchronous bit-frame-structured transport system on a digital subscriber line, the method comprising the steps of:
reserving bit positions for a respective link in a designated frame during setup configuration of the bit-frame-structured transport system; and
assigning time-division-multiplex-based bit positions temporarily unoccupied by the respective link to the ATM-based data link set up within the designated frame, without changing a location of the bit positions within the designated frame.

24. A method for operating time-division-multiplex-based telephone and ISDN data links with an ATM-based data link as claimed in claim 23, the method further comprising the steps of:
initiating a temporary assignment of the bit positions of a transmission channel with one of a command to disconnect a telephone call and a command to terminate an ISDN connection; and
initiating cancellation of the temporary assignment with one of a command to set up a telephone connection and a command to set up an ISDN connection, respectively.

25. A method for operating time-division-multiplex-based telephone and ISDN data links with an ATM-based data link as claimed in claim 24, wherein to initiate the temporary assignment, the commands used include Disconnect for assigning the bit positions of a telephone channel to the ATM link, Deactivate for assigning the bit positions of an ISDN channel to the ATM link, Establish for taking back the bit positions of a telephone channel into the telephony area, and Activate for taking back the bit positions of an ISDN channel into the ISDN area.

26. A method for operating time-division-multiplex-based telephone and ISDN data links with an ATM-based data link as claimed in claim 25, the method further comprising the step of controlling, after initiation of the respective assignment and taking-back, an ensuing procedural sequence by a line termination as master with a network termination as slave.

27. A method for operating time-division-multiplex-based telephone and ISDN data links with an ATM-based data link as claimed in claim 26, the method further comprising the steps of:
signaling, via the line termination, a new allocation of transmission channels and a channel allocation command to the network termination in a list of switchable channels; and
signaling, via the network termination, receipt of the channel allocation command with a channel allocation acknowledgement to the line termination.

28. A method for operating time-division-multiplex-based telephone and ISDN data links with an ATM-based data link as claimed in claim 27, the method further comprising the step of transmitting the channel allocation command and the channel allocation acknowledgement in an overhead area of the digital subscriber line frame.

29. A method for operating time-division-multiplex-based telephone and ISDN data links with an ATM-based data link as claimed in claim 28, the method further comprising the step of marking the channel allocation command and the channel allocation acknowledgement, respectively, by a message identifier, with message content being accommodated in at least one byte following the message identifier.

30. A method for operating time-division-multiplex-based telephone and ISDN data links with an ATM-based data link as claimed in claim 29, wherein the at least one byte is mirrored back in the channel allocation acknowledgement.

31. A method for operating time-division-multiplex-based telephone and ISDN data links with an ATM-based data link as claimed in claim 30, the method further comprising the step of initiating, via the line termination, a switchover procedure on receiving the channel allocation acknowledgement.

32. A method for operating time-division-multiplex-based telephone and ISDN data links with an ATM-based data link as claimed in claim 31, the method further comprising the step of using, in the digital subscriber line frame, at least two overhead bits protected by a cyclic redundancy check for signaling the switchover procedure, with bit significances being independent of one another in an upstream direction from the network termination to the line termination and in a downstream direction from the line termination to the network termination.

33. A method for operating time-division-multiplex-based telephone and ISDN data links with an ATM-based data link as claimed in claim 32, the method further comprising the step of forming a procedure reference time, measured in frame length, both in the line termination and in the network termination, the reference time including a loop delay between the line termination and the network termination, relevant time portions in the line termination and the network termination for cyclically redundancy checking and framing, and relevant time portions in the line termination and the network termination for changing the channel allocation in the digital subscriber line frame.

34. A method for operating time-division-multiplex-based telephone and ISDN data links with an ATM-based data link as claimed in claim 33, the method further comprising the step of configuring, independently, the line termination time portion and the network termination time portion for changing the channel allocation in the digital subscriber line frame when the digital subscriber line link is configured for the line termination and the network terminal.

35. A method for operating time-division-multiplex-based telephone and ISDN data links with an ATM-based data link as claimed in claim 34, wherein a framing unit in transmit equipment of the line termination and a framing unit in receive equipment of the network termination switchover to the new channel allocation for the designated frame, and a framing unit in transmit equipment of the network termination and a framing unit in receive equipment of the line termination switchover to the new channel allocation for the designated frame.

36. A method for operating time-division-multiplex-based telephone and ISDN data links with an ATM-based data link as claimed in claim 35, wherein the procedure reference time further includes a configurable time interval of any required size.

37. A method for operating time-division-multiplex-based telephone and ISDN data links with an ATM-based data link as claimed in claim 35, wherein the duplicated procedure reference time is configurably extended by an integral multiple of the procedure reference time.

38. A method for operating time-division-multiplex-based telephone and ISDN data links with an ATM-based data link as claimed in claim 35, wherein the digital subscriber line employs frames of a symmetric digital subscriber line, and the channel allocation command and the channel allocation acknowledgement are transmitted in the embedded operations channel.

39. A method for operating time-division-multiplex-based telephone and ISDN data links with an ATM-based data link as claimed in claim 38, wherein one bit or two adjacent bits in the message bytes of the channel allocation command and the channel allocation acknowledgement designate one of a B-channel time slot incorporating a telephone connection and two adjacent time slots incorporating an ISDN connection, respectively.

40. A method for operating time-division-multiplex-based telephone and ISDN data links with an ATM-based data link as claimed in claim 39, wherein a sequence of bits in the message bytes continuously corresponds to a sequence of the B-channel time slots in the frame.

41. A method for operating time-division-multiplex-based telephone and ISDN data links with an ATM-based data link as claimed in claim 40, wherein B-channel time slots which are one of temporarily switched to the ATM area and to be newly switched to the ATM area are identified by a logic one, and one of B-channel time slots in the basic telephony or ISDN setting and B-channel time slots to be switched back are identified by a logic zero.

42. A method for operating time-division-multiplex-based telephone and ISDN data links with an ATM-based data link as claimed in claim 41, wherein bit positions 24 and 36 in the overhead area of the frame of the symmetric digital subscriber line are used for the signaling bits.

43. A method for operating time-division-multiplex-based telephone and ISDN data links with an ATM-based data link as claimed in claim 35, wherein the digital subscriber line system employs non-interleaved frames of the asymmetric digital subscriber line, with the channel allocation command and the channel allocation acknowledgement being transmitted in a channel with high-level data link control of the asymmetric digital subscriber line overhead area and the channel allocation command and the channel allocaton acknowledgement addressing the bit positions of the transmission channels to be switched over.

44. A method for operating time-division-multiplex-based telephone and ISDN data links with an ATM-based data link as claimed in claim 43, wherin the bit positions of the asymmetric digital subscriber line frame are used for the signaling bits.
